(19) United States
(12) Patent Application Publication
(10) Pub. No.: US 2007/0000413 A1
(43) Pub. Date: Jan. 4, 2007

(54) Inorganic lightweight insulator and process for preparing it

(76) Inventors: Choongbum Park, Goyang (KR); Younghwan Kim, Kimpo (KR)

Correspondence Address: NIXON & VANDERHYE, PC, 901 NORTH GLEBE ROAD, 11TH FLOOR, ARLINGTON, VA, 22203, US

(21) Appl. No.: 11/367,427

(22) Filed: Mar. 6, 2006

(30) Foreign Application Priority Data
Jun. 29, 2005 (KR) 10-2005-0056833

(51) Int. Cl. C04B 40/00

(52) U.S. Cl. 106/820

(57) ABSTRACT

The present invention discloses an inorganic lightweight insulator manufactured by blending one or more selected from the group consisting of calcium carbonate, mica powder, clay, chloride, alumina, zeolite, talc, kaolin, diatomite, calcium carbonate and loess with a silicate compound and colloidal silica; adding an acid to change the mixture into a paste; and adding a foaming agent to the paste; and a process for preparing the inorganic lightweight insulator.

### TECHNICAL FIELD

The present invention relates to an inorganic lightweight insulator and a process for preparing it.

### BACKGROUND ART

As an insulator, it includes foamed polystyrene (hereinafter, called to “Styrofoam”), glass fiber, ceramic fiber, rock wool, silica board, urethane foam, polyethylene foam, etc. The gypsum board and silica board, especially, are known as a recent incombustible material.

The above insulators have been widely used as building materials, due to their excellent properties such as insulating effects, and inexpensiveness, etc. However, the above insulators, especially Styrofoam having been widely used generates toxic gases when fire occurs, which leads many casualties, and therefore its use for external materials is prohibited under the law, and also the use thereof is limited even to the panel and intermediate layers for walls of buildings. And also an inorganic fiber such as glass fiber causes cancer or severe damages to the bronchus, and therefore the use thereof have been strictly prohibited in most countries. And, asbestos has been completely prohibited as a building material, on the reason of causing cancer.

Recently, foam glasses have been used in various fields as materials substituting for the above insulators. Foam glass was developed by several companies such as Pittsburgh Corning Corp. and Elf Atochem in U.S.A. and has been used for FGD (Flue Gas Desulfurization) plant linings and insulators for ducts. Such foam glass has been manufactured by melting silica sand and additives to form the raw glass, crushing the obtained raw glass, crushing it finely after adding a foaming agent, mixing, foaming by sintering, annealing and forming. There are several inventions utilizing or developing the said manufacturing methods of the foam glass, for example Korean Patent No. 10-0246755, 10-0357895 and 10-0430437.

There were several drawbacks in the above methods. That is to say, in order to manufacture foam glass by the above method, after adding various additives to raw materials of the conventional glass, the mixture should be melted at about 1300° C. to 1600° C., crushed, mixed with a foaming agent, and annealed after foaming at 800° C. to 900° C. In such methods, a large amount of energy and facility cost are required, and moreover many parts are broken during a cutting process, and handling is not easy because their cut surfaces are sharp. Many inventors tried to solve the problems, but any method for manufacturing an insulator at the room temperature or low temperature has not been accomplished yet.

### DISCLOSURE OF THE INVENTION

In order to solve the above problems, the inventors of the present invention thought that mineral substances such as silicate compound, silica, calcium carbonate, chloride compound and mica should be used as nontoxic materials suitable for lightweight insulators. However, they were not proper for preparation of the lightweight insulator product, because energy consumption was high during the processes of melting, pulverization and sintering, and processing facilities were required to produce lightweight insulators with the above materials. Therefore, the present inventors realized that the inorganic compounds should be dissolved or processed to a paste at room temperature or low temperature. The present inventors have tried to use silicates such as cheap sodium silicate and silica with acid or alkali, and found that object of the treatment could not be accomplished because silicate compound itself was strongly alkaline. The inventor further realized that the silicate compound was changed to silicic acid, if the silicate compound was treated with an acid to be a neutral or acid condition; it was impossible to change the mixture into a paste because it was hard and had no fluidity; it was also impossible to manufacture insulators with the silicate compound because it was dissolved if contacted with water; foamed material might be obtained if water insoluble silica, specially colloidal silica, was mixed with silicate and foamed; and it had no value as a foamed material because it was dissolved if it was put into water. After blending silicate compound with one or more selected from the group consisting of colloidal silica, mica powder, clay and chloride, pH was adjusted to a range of 7.5 to 9.5 with a weak acid, and the mixture became a paste having fluidity. Furthermore, the inventor found that if the said mixture stored after adding a foaming agent thereto, the resulting mixture has lots of micropores showing the good thermal insulation property, water resistance, chemical resistance, hardness and strength. The present invention has been completed on the basis of such a finding.

The present invention provides an inorganic insulator using silicate and colloidal silica as main raw materials, and a manufacturing method thereof.

### BEST MODE FOR CARRYING OUT THE INVENTION

Hereinafter, the present invention is described in detail.

Even if sodium silicate and potassium silicate may be used as silicates, sodium silicates such as ortho-sodium silicate, meta-sodium silicate are much preferable due to easy obtainability, good blendability with other ingredients and foamability. Colloidal silica is a colloidal suspension of silicone dioxide (SiO₂), which has hydroxide ions on the surface of silica by hydration in water, and it can be prepared manufactured by adding hydrochloric acid to aqueous solution of sodium silicate. Recently, the various preparation of colloidal silica has been developed. For example, colloidal silica manufactured by dispersing in non-aqueous solution; micropowdery colloidal silica manufactured by vapor phase method. Such colloidal silica has particle diameters of several tens Angstrom(Å) to micrometers (μm). The colloidal silica particles have porous surfaces and generally are negatively charged in water. Any colloidal silica described in the above may be used, but colloidal silica manufactured by using aqueous solution of sodium silicate among them is most preferable in the aspect of being easy available on the market with a low cost.

The solution of silicate compound may be changed to a paste by adding an acid. However, if a strong acid is added to the silicate solution, it cannot be changed to a paste because severe hardening occurs. Paste is formed when pH is adjusted to be weakly acidic, neutral or weakly alkaline, namely pH 7 to 9.5, and preferably pH 8.0 to 9.5. For example of using sodium silicate, when sodium silicate solution is reacted with a small amount of weak acid, the sodium silicate solution is changed into the solution having the components of silicic acid, sodium hydrogen silicate and sodium silicate. That is to say, this solution is comprised of the various silicate compounds, say, of water soluble silicate such as sodium silicate; water insoluble silicate such as silicic acid; and water soluble sodium hydrogen silicate. Accordingly, such a solution can be changed to hard paste or soft paste, depending on pH degree. In this occasion, the kind of the acids is not limited, and also acidity thereof is not limited.

In the above, it is possible that only silicate is subjected to be neutral or weakly alkaline by treating with an acid, but the resulted product is not applicable for an insulator, since it is dissolved in water. If silicate is mixed with colloidal silica at a ratio between 1:9 and 9:1, acidified, and foamed, the resulted foamed material does not show forming cracks, and also is excellent in forming independent micropores. However, when the foamed material is put into water, it is dissolved, absorbs moisture in a humid room and is not suitable for a lightweight insulator. Therefore, other components should be added to the mixture in order to provide the properties of water insolubility and chemical resistance. A foamed material having excellent water resistance, chemical resistance and thermal insulation is obtained by blending one or more selected from the group consisting of mica powder, clay, various chlorides, alumina, zeolite, talc, kaolin, diatom, calcium carbonate and loess with the above mixture at a ratio of 5% to 70% by weight of the resultant blended silicate and colloidal silica mixture; adding an acid to form paste; and storing after adding a foaming agent.

The various chlorides described in the above include aluminum chloride, calcium chloride, magnesium chloride, zinc chloride, aluminum polychloride and ferric chloride (FeCl₃). Such chlorides may improve water resistance and thermal insulation of a final foamed material.

Any foaming agent may be used, for example, the inorganic compounds such as hydrogen peroxide, ammonium bicarbonate, manganese dioxide, potassium dichromate, ammonium carbonate and ammonium nitrate; and organic compounds such as azobisisobutyronitrile(AIBN), azobisamide, perbenzoic acid and 4,4′-oxybis(benzenesulfonyl)hydrazide may be used.

The reaction, after adding a foaming agent to the mixture, may be carried out at the room temperature to about 200° C. When an inorganic foaming agent is used, foam formation may be completed within about 2 to 4 hours at the room temperature to about 40° C. When an organic foaming agent is used, foam formation is smoothly completed at about 110° C. to 200° C. Either an inorganic foaming agent or an organic foaming agent can be used, but the inorganic foaming agent is preferable in the aspect of easy foam formation, handling and energy saving.

### EXAMPLES

Hereinafter, the present invention is described in detail with reference to example embodiments.

### Example 1

One liter of sodium silicate solution (about 40% Na₂Si₃O₇) was stirred, and stirred sufficiently after adding 6 liters of colloidal silica and 60 g of aluminum chloride; 0.1 N hydrochloric acid was slowly added thereto under stirring; and paste was formed about pH 9.0 having viscosity, where the stirrer is not operated almost, and stirring is stopped. The paste was taken out and kneaded for 30 minutes by a kneader, 100 Ml of 35% hydrogen peroxide was slowly added thereto during kneading, and the paste was spread in a thickness of 10 mm. After 4 hours, the paste was dried in an oven at 40° C., for about 30 minutes, to produce a foamed lightweight insulator.

The lightweight insulator was cut into a sample of 3 ×3 cm². The sample was put into a beaker with water and stored for 30 days, and moisture absorption was not observed. In addition, it was treated with 1 N hydrochloric acid and 1 N sodium hydroxide, and no change was observed.

The physical properties such as density, coefficient of heat conduction, compression strength and flame retardancy of the lightweight insulator were measured by Korea Testing and Research Institute for Chemical Industry as follows.

Density : 448 kg/m³ (test method: KS L 9016 : 1995)

Coefficient of heat conduction (average temperature: 20±3° C.): 0.086 W/mK (test method: KS L 9016 : 1995(flat plate heat flow meter method))

Compression strength: 0.7 MPa (test method: KS L 9204 : 2002(*))

Flame retardancy: flame retardant (test method KS M 3015 : 2003(A))

### Example 2

A foamed lightweight insulator of Example 2 was manufactured by the same method as Example 1 except that 6 g of calcium chloride and 6 g of mica powder were added instead of aluminum chloride. The foamed lightweight insulator of Example 2 showed almost same properties of thermal insulation, water resistance and chemical resistance as Example 1. Additionally, when 20 g of a stainless steel ball were dropped on the surface of the insulator from the height of 1 meter, the surface of the insulator was not damaged.

### INDUSTRIAL APPLICABLITY

According to the present invention as described in the above, a foamed material having excellent properties as a lightweight insulator may be obtained without environmental pollution by blending silicate compound, colloidal silica, mica and chloride; and adding a foaming agent thereto to generate foam. According to the present invention, an insulator may be obtained by forming a paste and foaming and by performing the reaction at room temperature or low temperature. The insulator may be utilized usefully as a sandwich panel, plate shape, spherical shape, interior material and shockproof packaging material.

What is claimed is:

1. An inorganic lightweight insulator manufactured, which comprises by mixing silicate compound and colloidal silica at a ratio between 1:9 and 9:1;
blending one or more selected from the group consisting of calcium carbonate, mica powder, clay, chloride, alumina, zeolite, talc, kaolin, diatomite, calcium carbonate and loess with the mixture at a ratio of 5% to 70% by weight to the above resultant blended mixture; adding an acid to control the blended mixture at pH about 7.5 to 9.5, thereby changing the mixture into a paste; and adding a foaming agent.

2. The inorganic lightweight insulator of claim 1, wherein the silicate compounds is sodium silicate.

3. The inorganic lightweight insulator of claim 1, wherein the chloride is one or more selected from the group consisting of aluminum chloride, calcium chloride, magnesium chloride, zinc chloride, aluminum polychloride and ferric chloride.

4. The inorganic lightweight insulator of claim 1, wherein foaming agent is one or more selected from the group consisting of hydrogen peroxide, ammonium bicarbonate, manganese dioxide, potassium dichromate, ammonium carbonate ammonium nitrate, azobisiso-butyronitrile (AIBN), azobisamide, perbenzoic acid and 4,4′-oxybis(benzenesulfonyl)hydrazide.

5. A process for preparing an inorganic lightweight insulator comprising the steps of:
mixing silicate compound and colloidal silica at a ratio between 1:9 and 9:1;
blending one or more selected from the group consisting of calcium carbonate, mica powder, clay, chloride, alumina, zeolite, talc, kaolin, diatomite, calcium carbonate and loess with the resulted mixture at a ratio of 5% to 70% by weight to the above resultant blended mixture;
adding an acid to change the blended mixture into a paste;
kneading the mixture; and
adding a foaming agent.
